(19) United States
(12) Patent Application Publication
(10) Pub. No.: US 2025/0273852 A1
(43) Pub. Date: Aug. 28, 2025

(54) SYSTEM AND METHODS FOR POWERING SECONDARY UNMANNED AERIAL SYSTEMS OF A POP-UP HF ANTENNA SYSTEM

(71) Applicant: Raytheon Company, Tewksbury, MA (US)

(72) Inventors: David D. Crouch, Farragut, TN (US); Kenneth V. Miller, Rancho Cucamonga, CA (US)

(21) Appl. No.: 18/587,363

(22) Filed: Feb. 26, 2024

(51) Int. Cl. H01Q 3/02; H01Q 1/28; H04B 10/25

(52) U.S. Cl. CPC H01Q 3/02; H04B 10/25; H01Q 1/285

(57) ABSTRACT

A pop-up HF antenna system includes a primary UAS associated with a feed point of the pop-up HF antenna. The primary UAS has a first input configured to receive an RF signal and a second input configured to receive a DC power signal. At least one secondary UAS are associated with an endpoint of the pop-up HF antenna. a pair of wires is configured to interconnect the primary UAS to the at least one secondary UAS and to provide the DC power signal and the RF signal from the primary UAS to the at least one secondary UAS. At least one antenna interface circuit located at the primary UAS and configured to connect the primary UAS to the pair of wires and to combine the DC power signal and the RF signal. The pair of wires is configured to provide simultaneous differential-mode DC transmission and common-mode RF transmission.

### TECHNICAL FIELD

This disclosure relates generally to pop-up HF (high frequency) antennas. More specifically, this disclosure relates to providing power from a primary Unmanned Aerial System (UAS) to secondary UAS within a pop-up HF antenna.

### BACKGROUND

Pop-up HF antennas are used for providing communications in both military and civilian applications. A pop-up HF antenna is a UAS-supported HF antenna that is rapidly deployable, reconfigurable, and requires no fixed infrastructure. The pop-up HF antennas are supported at their feed and endpoints by tethered UAS. Antenna agility and reconfigurability require endpoint mobility with respect to the tethered UAS at the endpoints. However, the endpoint mobility can be constrained by the use of tethered secondary UAS that require physical connections to provide power to the UAS.

### SUMMARY

This disclosure relates to providing power from a primary UAS to secondary UAS within a pop-up HF antenna system.

One aspect thereof comprises a pop-up HF antenna system including a primary UAS associated with a feed point of the pop-up HF antenna. The primary UAS has a first input configured to receive an RF signal and a second input configured to receive a DC power signal. At least one secondary UAS are associated with an endpoint of the pop-up HF antenna. A pair of wires is configured to interconnect the primary UAS to a secondary UAS of the at least one secondary UAS and provide the DC power signal to the secondary UAS and the RF signal from the primary UAS toward the secondary UAS. At least one of antenna interface circuit located at the primary UAS is configured to connect the primary UAS to the pair of wires and combine the DC power signal and the RF signal received at the primary UAS. The pair of wires is configured to provide simultaneous differential-mode DC transmission and common-mode RF transmission between the primary UAS and the secondary UAS.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates the manner currently utilized for providing both DC power and RF signals to the feed point UAS and endpoint UAS of a pop-up HF antenna system;

FIG. 2 illustrates a manner for providing both DC power and RF signals from a UAS at a feed point of the pop-up HF antenna system to secondary UAS at the endpoints without using a tethered power connection;

FIG. 3 illustrates a model of the dual wire connection between a primary UAS and a secondary UAS for providing both DC power and RF signals;

FIG. 4 illustrates the system for providing both DC power and RF signals from a primary UAS to a pair of secondary UAS via a connection comprising a pair of wires; and

FIG. 5 illustrates the pair of wires indicating a secondary UAS through a single spool having slip ring interfaces.

### DETAILED DESCRIPTION

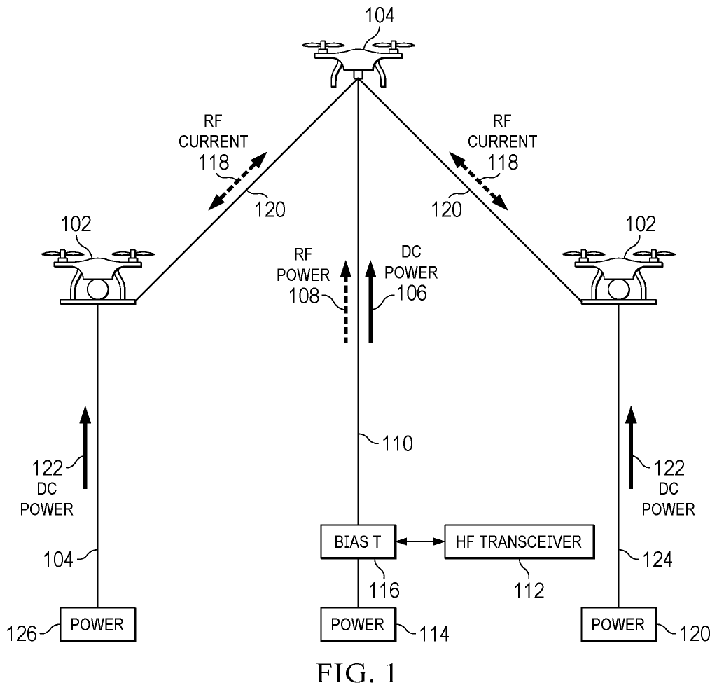

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Referring now to FIG. 1, there is illustrated the manner in which secondary UAS (unmanned aerial system) or UAS 102 are currently powered within a pop-up HF antenna system. A UAS may include an unmanned aircraft/drone, a balloon, and/or an airborne node, device or sensor. A primary UAS or UAS 104 is provided at the feed point of the pop-up HF antenna system. The primary UAS 104 receives both DC power 106 and RF power 108 over a connection 110. The RF power 108 is provided from a high-frequency (HF) transceiver 112 while the DC power 106 is provided from power circuitry 114. The RF power 108 and DC power 106 provided from the HF transceiver 112 and power circuitry 114, respectively, are combined together by a bias tee circuit 116 for transmission over the connection 110. The secondary UAS 102 support the antenna endpoints from the primary UAS 104 at the feed point via connections 120. The RF energy that is transmitted from primary UAS 104 toward the secondary UAS 102 is radiated into free space by the connections 120. The secondary UAS 102 at the endpoints receive their DC power 122 over a tethered ground connection 124 provided from associated ground power circuitry 126. Thus, the RF current 118 and DC power 122 are provided over two separate connections 120 and 124, respectively. This requires each of the secondary UAS 102 at the pop-up HF antenna endpoints to be ground tethered to their associated ground power circuitry 126.

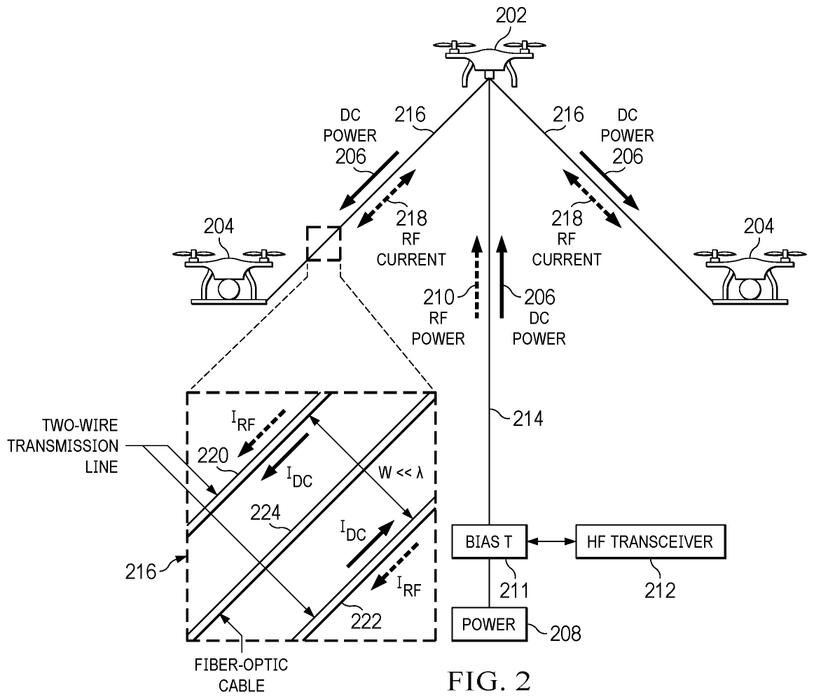

Requirements of antenna agility and reconfigurability of pop-up HF antennas require endpoint mobility. This endpoint mobility is constrained by the use of ground tethered UAS 102 to support antenna endpoints as illustrated in FIG. 1. Referring now to FIG. 2, there is illustrated a pop-up HF antenna utilizing paired wire connections between the primary UAS 202 and the secondary UAS 204. The pop-up HF antenna illustrated in FIG. 2 receives its DC power signal 206 from power circuitry 208 located at a ground station and its RF power signal 210 from an HF transceiver 212 located at the ground station. The DC power signal 206 and RF power signal 210 are combined at a bias tee circuit 211 and transmitted up to the feed point at the primary UAS 202 over a connection 214. Both the DC power signal 206 and RF power signal 210 travel from the bias tee circuit 211 at the ground station up to the feed point of the antenna at the primary UAS 202. The primary UAS 202 has a connection 216 to each of the secondary UAS 204 comprising the endpoints of the pop-up HF antenna. The connection 216 as will be more fully described hereinbelow, enables both the transmission of the DC power signal 206 from the primary UAS 202 to the secondary UAS 204 and the transmission of the RF current signals 218 along the connection between the primary UAS 202 and the secondary UAS 204. The system as illustrated in FIG. 2, enables the secondary UAS 204 to be untethered to the ground and only have the connection 216 to the feed point associated with the primary UAS 202. This allows for more flexible positioning of the endpoints of the pop-up HF antenna as the secondary UAS 204 may be moved to any desired location to improve the operations of the pop-up HF antenna. The elimination of the tethers on the secondary UAS 204 eliminates a constraint and enhances the pop-up HF antenna agility and reconfigurability.

Referring now to the exploded view illustrated in FIG. 2 of the connection 216 between the primary UAS 202 and one of the secondary UAS 204, the details of the link are more fully illustrated. It should be realized that the connection 216 to each of the UAS 204 from the primary UAS 202 will be identical. The connection 216 will comprise a pair of wires 220 and 222. The pair of wires 220 and 222 are closely spaced wires having a spacing much less than the RF wavelength λ. The pair of wires 220 and 222 provide an RF currents having the same magnitude and direction at each point along the lengths of wires 220 and 222. The current travels back and forth between the primary UAS 202 and the secondary UAS 204. This comprises a common mode RF signal. Additionally, the DC power current I_{DC} travels from the primary UAS 202 to the secondary UAS 204 over transmission wire 220 while current I_{DC} returns to the secondary UAS 204 to the primary UAS 202 on the transmission wire 222. Thus, the DC current flows in opposite directions on the two wires providing a return path to ground as a differential-mode DC power signal.

In a further embodiment, a fiber-optic cable 224 may be added between the transmission wire pair 220 and 222 to provide for high-speed two way data transmission between the primary UAS 202 and the secondary UAS 204. However, use of the fiber-optic cable 224 is not necessary in order to transmit the RF signal and the DC power signal between the primary UAS 202 and secondary UAS 204. In another embodiment, rather than utilizing a fiber-optic cable for high-speed data transmissions between the primary UAS 202 and the secondary UAS 204, a Wi-Fi connection or a 60 GHz wireless connection can be established between the secondary UAS 204 and the ground station in order to provide increased data transmission capability.

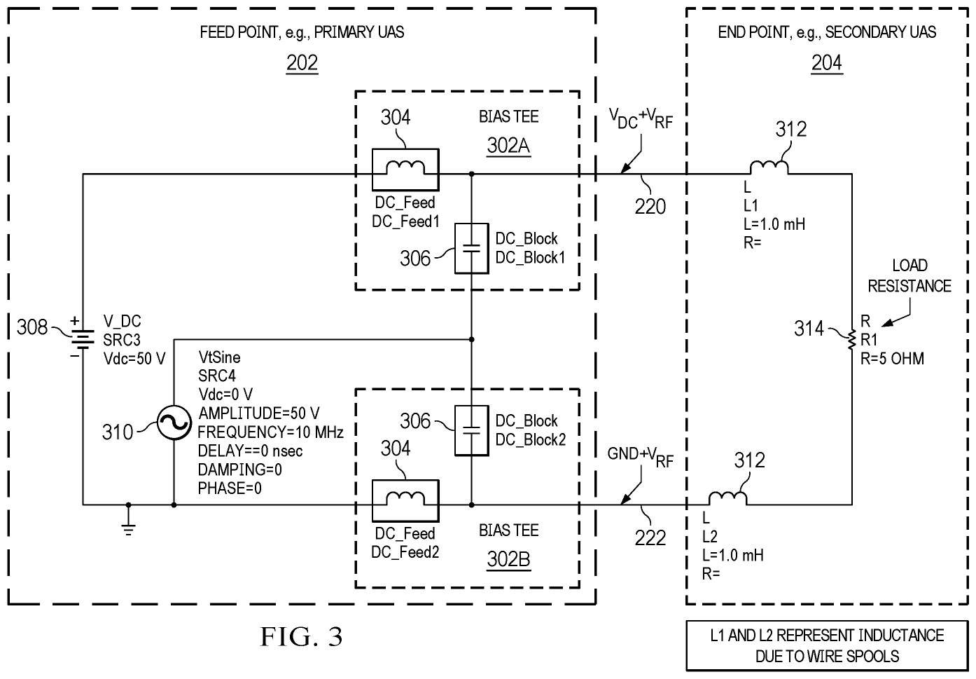

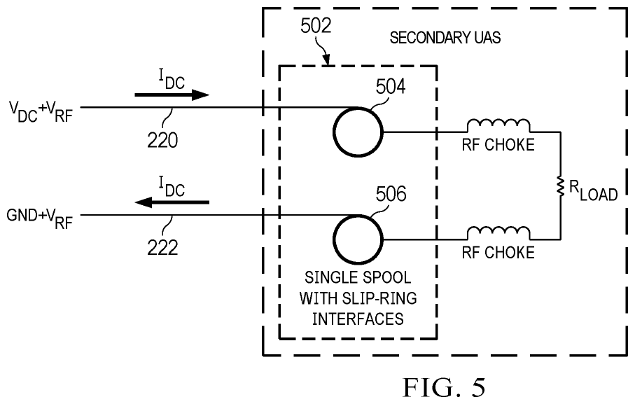

The connections to the pair of wires 220 and 222 that form that the connection 216 between the primary UAS 202 and the secondary UAS 204 are provided via a pair of bias tee circuits 302 as more particularly illustrated in FIG. 3. FIG. 3 shows an idealized bias tee circuit 302 that includes idealized components. Inductor 304 is connected to the DC voltage source 308 provided from the ground station and the capacitor is used to block the DC signal from the RF signal. The RF signal is provided from RF source 310. The bias tee circuit 302A is connected to transmission wire 220 and the bias tee circuit 302B connected to transmission wire 222. The bias tee circuits 302 combined the RF signal which are transmitted toward the secondary UAS 204 and radiated by the wires 220 and 222 and the DC power signal for transmission over the wire pair to the secondary UAS 204. The two parallel wires 220 and 222 behave as a single RF conductor for transmitting the RF signal from the primary UAS 202 towards the secondary UAS 204 to be radiated from the wires 220 and 222 while providing the DC current I_{DC} forward and return paths on the separate wires 220 and 222. The secondary UAS 204 includes a pair of inductors 312 that are associated with wire spools that may be used for increasing and decreasing the length of the wires 220 and 222, and thus the distance between the feed point of the primary UAS 202 and the endpoints of the secondary UAS 204. This will be more fully described with respect to FIG. 5. Resistor 314 represents a load resistance of the secondary UAS 204.

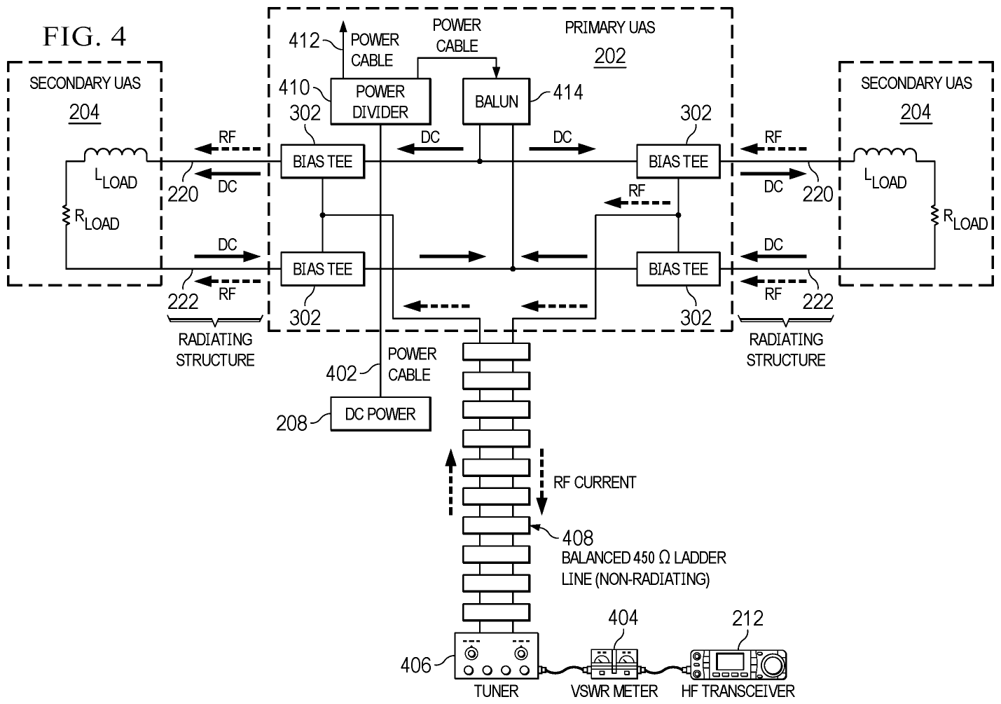

Referring now to FIG. 4, there is more particularly illustrated the system configuration of the manner for providing both RF signals and DC signals between a primary UAS 202 and a secondary UAS 204 over a single wire pair within a pop-up HF antenna. At the primary antenna feed point supported by the primary UAS 202, N pairs of bias tee circuits 302 are used to transmit the RF signal to be radiated and DC power onto N pairs of wires 220,222. N is the number of wire antenna arms. Thus, N equals 2 for a conventional half-wave dipole antenna. Each pair of wires joins the primary UAS 202 to one of the secondary UAS 204. The corresponding pair of bias tee circuits 302 couples the same RF signal onto both wires 220 and 222. The DC voltage on one wire 220 is positive while the other wire 222 is grounded and provides a return path for current from the secondary UAS 204.

As described previously, the ground station associated with the primary UAS 202 includes an HF transceiver 212 and DC power circuitry 208. The DC power circuitry 208 is provided to the primary UAS 202 over a power cable 402 within the ground tether. The RF signals are provided to the primary UAS 202 by providing the generated RF signals from the HF transceiver 212 to a the SWR (standing wave ratio) meter 404 and then to a tuner 406. The RF signals are provided from the ground station to the primary UAS 202 over a balanced 450-ohm ladder line that is non-radiating.

Each of the secondary UAS 204 are connected to the primary UAS 202 via a wire pair consisting of wire 220 and wire 222, respectively. The wires 220 and 222 should not touch as contact will short out the flow of DC power to the secondary UAS 204. Each of the wires 220 and 222 need to be insulated. In one embodiment, this is done by forming a thin ribbon in which the two wires (and perhaps the fiber optic cable) are embedded within an insulating and flexible dielectric material such as polyethylene. The connection can also be fabricated with a circular cross section which would be useful when spooling the wire as described below. Each of the wires 220 and 222 are connected to the primary UAS 20 using a bias tee circuit 302 as described hereinabove with respect to FIG. 3. The RF signal provided over the ladder line 408 is provided to each of the bias tee circuits 302 within the primary UAS 202. The DC power signal is provided to a power divider circuit 410 that divides the received power into a primary power output for the primary UAS 412 and a power input to a balun 414 for providing the DC power signal to each of the bias tee circuits 302. The bias tee circuits 302 provide the common mode RF signals and the differential mode DC power signals to each of the secondary UAS 204. Each connection between the primary UAS 202 and the secondary UAS 204 provides simultaneous differential-mode DC transmission and common-mode RF transmission within a two-wire approach.

In addition to providing transmission of the RF and DC signals, the two-line wire pair consisting of wire 220 and 222 further acts as a radiating structure for the pop-up HF antenna. The frequency of the antenna can be altered by changing the length of the wires 220 and 222 interconnecting a secondary UAS 204 with a primary UAS 202. The frequency can be increased by decreasing the length of the wires 220 and 222 of the antenna. Similarly, the frequency of the antenna can be decreased by increasing the length of the wires 220 and 222 of the antenna. The increase and decrease of the length of the wires 220 and 222 may be achieved using a spool structure associated with the secondary UAS 204 as more particularly illustrated in FIG. 5.

FIG. 5 illustrates the use of a single spool having slip ring interfaces 502. The first wire 220 providing the current I_{DC} into the secondary UAS 204 having a voltage V_{DC}+V_{RF} thereon. The wires 220 and 222 can be lengthened or shortened by spooling the wire on or taking wire off spool 504. The second wire 222 providing the current I_{DC} from the secondary UAS 204 having a voltage GND+V_{RF} thereon. It should be appreciated the spool 504 comprises a single spool for both wires 202 and 222. RF chokes may or may not be needed. This would further isolate the load from RF, but RF voltage across the output is already zero, and wire spools already provide inductance. Use a combined fiber optic rotary joint/slip ring may be used to transition optical and DC signals from ribbon to secondary UAS.

Using the above-described system and method, a pop-up HF antenna may be provided that does not have secondary UAS endpoints that are limited by power tethers required for the secondary UAS. The secondary UAS may be placed and moved to any location to optimize antenna performance while continuing to receive power from the primary UAS.

While the above-described methods and systems are well suited for a pop up antenna implemented using unmanned aerial systems and devices, it should be appreciated that other non UAS based implementations are possible. For instance, in one example embodiment, an HF antenna installation having fixed endpoints (e.g., such as those used by ham radio operators) is implemented. The HF antenna installation may have antenna feed and endpoints supported by existing structures or dedicated support poles. In some case, it is advantageous to provide power to the end points to support operation of electrical equipment such as lights, sensors, weather monitoring equipment, etc. Thus, in such a scenario, a non UAS implementation of the invention is useful where the primary and secondary UAS are replaced by fixed structures supported by or permanently affixed to the ground.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A pop-up HF antenna system comprising:
a primary UAS associated with a feed point of the pop-up HF antenna, the primary UAS having a first input configured to receive an RF signal and a second input configured to receive a DC power signal;
at least one secondary UAS associated with an endpoint of the pop-up HF antenna;
a pair of wires configured to interconnect the primary UAS to the at least one secondary UAS and to provide the DC power signal to the at least one secondary UAS and the RF signal from the primary UAS toward the at least one secondary UAS; and
at least one antenna interface circuit located at the primary UAS and configured to connect the primary UAS to the pair of wires and to combine the DC power signal and the RF signal for transmission to the connected secondary UAS over the pair of wires;
wherein the pair of wires is configured to provide simultaneous differential-mode DC transmission and common-mode RF transmission between the primary UAS and the connected secondary UAS.

2. The pop-up HF antenna system of claim 1,
wherein the at least one secondary UAS comprises a plurality of secondary UAS;
wherein the system further comprises additional pairs of wires, each additional pair of wires connecting the primary UAS to a secondary UAS of the plurality of secondary UAS; and
wherein the at least one antenna interface circuit comprises additional antenna interface circuits, each additional antenna interface circuit configured to connect the primary UAS to a pair of wires of the additional pairs of wires and to combine the DC power signal and the RF signal for transmission to a connected secondary UAS of the plurality of secondary UAS.

3. The pop-up HF antenna system of claim 1, further comprising:
a fiber optic cable associated with the pair of wires connecting the primary UAS to the at least one secondary UAS and configured to provide a high-speed data connection therebetween.

4. The pop-up HF antenna system of claim 1, further comprising:
a power divider circuit connected to a second input of the primary UAS and configured to divide the received DC power signal and provide a first DC power signal for the primary UAS and a second DC power signal for the at least one secondary UAS.

5. The pop-up HF antenna system of claim 4, further comprising:
a balun circuit connected to receive the second DC power signal, the balun further connected to each of a plurality of pairs of bias tee circuits.

6. The pop-up HF antenna system of claim 1, further comprising:
a spool with slip-ring interfaces associated with the pair of wires connected to the at least one secondary UAS and configured to selectively lengthen and shorten the wire connected thereto;
wherein a frequency of the pop-up HF antenna is increased by shortening the pair of wires connected to the spool and decreased by lengthening the pair of wires connected to the spool.

7. The pop-up HF antenna system of claim 1, wherein the at least one antenna interface circuit comprises a pair of bias tee circuits associated with the pair of wires.

8. The pop-up HF antenna system of claim 1, further comprising:
a ground unit connected to the primary UAS via a wired connection and configured to provide the RF signal and the DC power signal to the primary UAS via the wired connection.

9. The pop-up HF antenna system of claim 8, further comprising:
a wireless connection between the ground unit and the at least two secondary UAS and configured to provide a data connection therebetween.

10. A method for distributing power within a pop-up HF antenna system comprising:
receiving an RF signal at a first input of a primary UAS at a feed point of the pop-up HF antenna;
receiving a DC power signal at a second input of the primary UAS at the feed point of the pop-up HF antenna;
providing the DC power signal and the RF signal from the primary UAS to at least one secondary UAS using a pair of wires between the primary UAS and the at least one secondary UAS and using an antenna interface circuit to combine the DC power signal and the RF signal for transmission toward the at least one secondary UAS; and
providing simultaneous differential-mode DC transmission to the at least one secondary UAS and common-mode RF transmission from the primary UAS toward the at least one secondary UAS over the connecting pair of wires.

11. The method of claim 10, further comprising:
using a fiber optic cable associated with the pair of wires connecting the primary UAS to the at least one secondary UAS in order to provide a high-speed data connection therebetween.

12. The method of claim 10, further comprising:
dividing the received DC power signal using a power divider circuit connected to the second input of the primary UAS; and
providing a first DC power signal for the primary UAS and a second DC power signal for the at least one secondary UAS.

13. The method of claim 12, further comprising:
receiving the second DC power signal at a balun circuit; and
providing the second DC power signal to each of the pairs of bias tee circuits.

14. The method of claim 10, further comprising:
selectively lengthening and shortening the pair of wires connected to the at least one secondary UAS via a spool with slip-ring interfaces;
increasing a frequency of the pop-up HF antenna by shortening the pair of wires connected to the spool; and
decreasing the frequency of the pop-up HF antenna by lengthening the pair of wires connected to the spool.

15. The method of claim 10, wherein providing the DC power signal and the RF signal further comprises providing the DC power signal and the RF signal using a pair of bias tee circuits associated with the pair of wires.

16. The method of claim 10, further comprising:
providing the RF signal and the DC power signal to the primary UAS via the wired connection from a ground unit connected via a wired connection.

17. An antenna system, comprising:
a primary feed point of the antenna system, the primary feed point including a first input configured to receive an RF signal and a second input configured to receive a DC power signal;
at least one secondary endpoint of the antenna system;
a pair of wires configured to interconnect the primary feed point to the at least one secondary endpoint and to provide the DC power signal to the at least one secondary endpoint and the RF signal from the primary feed point to the at least one secondary endpoint; and
at least one antenna interface circuit configured to connect the primary feed point to the pair of wires and to combine the DC power signal and the RF signal for transmission to the connected secondary endpoint over the pair of wires;
wherein the pair of wires is configured to provide simultaneous differential-mode DC transmission and common-mode RF transmission between the primary feed point and the connected secondary end point.

18. The antenna system of claim 17,
wherein the at least one secondary endpoint comprises a plurality of endpoints;
wherein the system further comprises additional pairs of wires, each additional pair of wires connecting the primary feed point to a secondary endpoint of the plurality of secondary endpoints; and
wherein the at least one antenna interface circuit comprises additional antenna interface circuits, each additional antenna interface circuit configured to connect the primary feed point to a pair of wires of the additional pairs of wires and to combine the DC power signal and the RF signal for transmission to a connected secondary endpoint of the plurality of secondary endpoints.

19. The pop-up HF antenna system of claim 17, further comprising:
a power divider circuit connected to a second input of the primary feed point and configured to divide the received DC power signal and provide a first DC power signal for the primary feed point and a second DC power signal for the at least one secondary endpoint.

20. The pop-up HF antenna system of claim 17, further comprising:
a spool with slip-ring interfaces associated with the pair of wires connected to the at least one secondary endpoint and configured to selectively lengthen and shorten the wire connected thereto;
wherein a frequency of the pop-up HF antenna system is increased by shortening the pair of wires connected to the spool and decreased by lengthening the pair of wires connected to the spool.
